(19) United States
(12) Patent Application Publication
(10) Pub. No.: US 2013/0079978 A1
(43) Pub. Date: Mar. 28, 2013

(54) PRECONDITIONING A VEHICLE

(71) Applicant: Robert Uyeki, Torrance, CA (US)

(72) Inventor: Robert Uyeki, Torrance, CA (US)

(73) Assignee: Honda Motor Co., Ltd., Tokyo (JP)

(21) Appl. No.: 13/240,775

(22) Filed: Sep. 22, 2011

(51) Int. Cl. B60H 1/00

(52) U.S. Cl. 701/36

(57) ABSTRACT

A prediction is made as to a start time of a next time trip by a vehicle. The start time is predicted based on previous trips by the vehicle. Forecast weather information is obtained for a time period that includes or is proximate to the start time. Based on the forecast weather information, conditions in the cabin are predicted at the start time and a preconditioning time is determined for initiating the preconditioning of the cabin. At the preconditioning time, if the conditions in the cabin are within a set range of the predicted conditions, the cabin is preconditioned.

### FIELD OF THE EMBODIMENTS

The embodiments generally relate to electric vehicles and more particularly to preconditioning the interior environment of electric vehicles.

### BACKGROUND

Electric vehicles are vehicles that use one or more electric engines for propulsion of the vehicle. The electric engines are powered by rechargeable batteries on-board the vehicle. Because electric vehicles are powered by on-board batteries, their driving range is limited by the amount of energy in their batteries.

In addition to the electric engines, a system of an electric vehicle that consumes the energy of the vehicle's batteries and as a result reduces the vehicle's driving range is the climate control system. The climate control system ensures that the cabin of a vehicle is comfortable for the driver and passengers. For example, if it is uncomfortably hot in the vehicle's cabin, the climate control system blows cool air into the cabin. If there is condensation on the windshield, the system blows hot air onto the windshield. Even though the climate control system reduces the driving range of an electric vehicle, majority of drivers are unwilling to stop the usage of the system because of the comfort it provides.

Thus, there is a need for a way to be able to manage the climate control system of an electric vehicle in a manner that minimizes the effect on the vehicle's driving range.

### SUMMARY

The embodiments provide a computer based method, a computer readable storage medium, and a vehicle system for preconditioning the cabin of an electric vehicle. When the vehicle has been turned off after the end of a trip and connected to a charging station for charging, a prediction is made as to a start time of a next time trip by the vehicle. The start time is predicted based on previous trips by the vehicle.

Forecast weather information is obtained for a time period that includes or is proximate to the start time. Based on the forecast weather information, conditions in the cabin are predicted at the start time and a preconditioning time is determined for initiating the preconditioning of the cabin. At the preconditioning time, if the conditions in the cabin are within a set range of the predicted conditions, the cabin is preconditioned.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the present subject matter.

### BRIEF DESCRIPTION OF THE DRAWINGS

FIG. 1 is a high-level block diagram of a vehicle communication environment according to one embodiment.

FIG. 2 is a high-level block diagram illustrating a detailed view of a preconditioning unit according to one embodiment.

FIG. 3 is a high-level block diagram illustrating a detailed view of a tracking server according to one embodiment.

FIG. 4 is a flow chart of a method for preconditioning the cabin of an electric vehicle according to one embodiment.

FIG. 5 is a flow chart of a method for predicting a start time of a next trip by an electric vehicle according to one embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Reference in the specification to “one embodiment” or to “an embodiment” means that a particular feature, structure, or characteristic described in connection with the embodiments is included in at least one embodiment. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments could be embodied in software, firmware or hardware, and when embodied in software, could be downloaded to reside on and be operated from different platforms used by a variety of operating systems.

The embodiments also relates to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the embodiments are not described with reference to any particular programming language. It will be appreciated that a variety of programming languages may be used to implement the teachings of the embodiments, and any references below to specific languages are provided for enablement and best mode of the embodiments.

In addition, the language used in the specification has been principally selected for readability and instructional purposes, and may not have been selected to delineate or circumscribe the inventive subject matter. Accordingly, the embodiments are intended to be illustrative, but not limiting, of the scope of the embodiments, which is set forth in the claims.

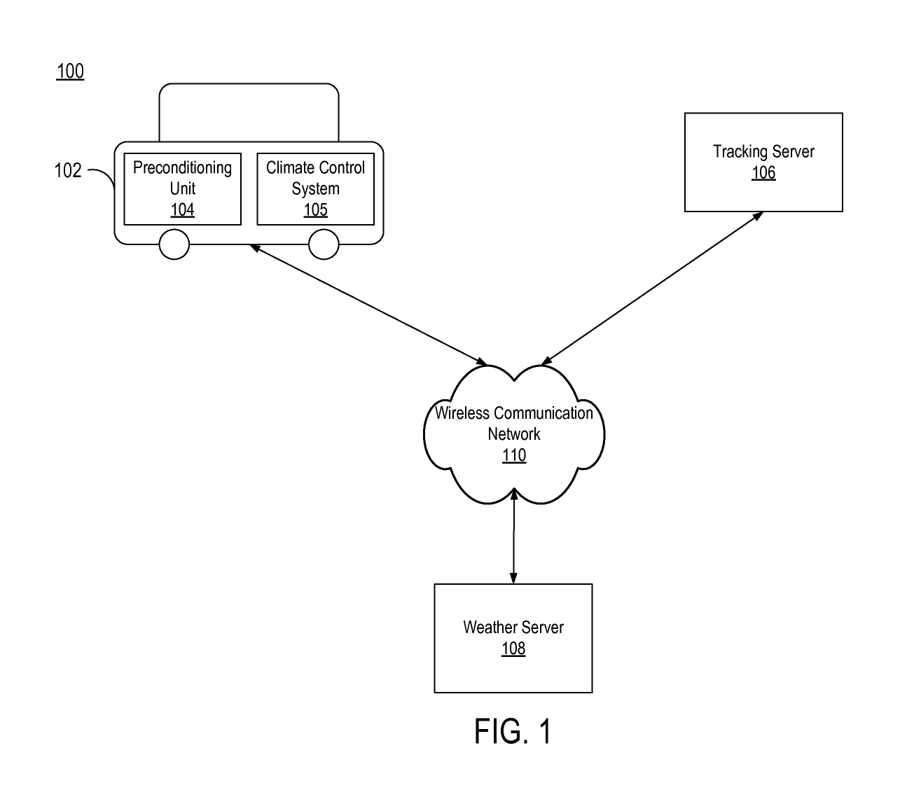

FIG. 1 is a high-level block diagram of a vehicle communication environment 100 according to one embodiment. FIG. 1 illustrates an electric vehicle 102, a tracking server 106, and a weather server 108 connected by a wireless communication network 110.

The electric vehicle 102 represents a vehicle that contains one or more electric engines for propulsion of the vehicle 102. The electric engines are powered by rechargeable batteries on-board the vehicle 102. The on-board batteries are charged when the vehicle 102 is connected to a charging station that supplies electric energy to the vehicle 102. For example, the batteries may be charged by connecting the vehicle 102 to a charging station that draws power from a power grid. In one embodiment, the on-board batteries are also charged using regenerative braking. In one embodiment, the electric vehicle 102 is purely electric in that the one or more engines of the vehicle 102 are electric. In another embodiment, the electric vehicle 102 has both an electric engine and internal combustion engine. As used herein, the amount of energy remaining in the vehicle's batteries for propulsion of the vehicle 102 may be referred to as the energy of the vehicle 102, the vehicle's state of charge or the batteries' state of charge.

The electric vehicle 102 includes a preconditioning unit 104 and a climate control system 105. The preconditioning unit 104 preconditions the environment of the vehicle's cabin according to the settings of a user. The cabin is the space inside the vehicle 102 where the driver and passengers are located when traveling in the vehicle 102 (i.e., where the driver and passengers sit). Preconditioning the cabin includes making the cabin comfortable for the driver of vehicle 102 prior to the start of a trip. In one embodiment, the cabin is made comfortable by bringing the temperature in the cabin to a temperature set by a user and by eliminating condensation and frost from the vehicle's windows when necessary. In one embodiment, the preconditioning unit 104 uses the climate control system 105 to precondition the vehicle 102. The climate control system 105, which may also be referred to as a HVAC (Heating, Ventilation, and Air Conditioning) system, heats, cools, and ventilates the vehicle's cabin. The climate control system 105 additionally defrosts one or more windows of the vehicle 102 (e.g., the windshield and rear window)

In one embodiment, the vehicle 102 is preconditioned prior to the start of a trip only if the vehicle 102 is connected to a charging station (i.e., charging). This allows for the vehicle 102 to be preconditioned using electric energy from the charging station instead of the vehicle's batteries, which in turn helps maximize the driving range of the vehicle 102.

In one embodiment, to precondition the electric vehicle 102, when the preconditioning unit 104 detects the end of a trip and that the vehicle 102 has been connected to a charging station for charging, the preconditioning unit 104 identifies a start time of a next trip by the vehicle 102 (i.e., the start time of the trip that is subsequent to the trip that just ended). In one embodiment, the start time is predicted by the tracking server 106 based on previous trips by the vehicle 102. The tracking server 106 provides the start time to the preconditioning unit 104.

The preconditioning unit 104 obtains forecast weather information from the weather server 108 for the location of the vehicle 102 at a time range that includes or is proximate to the start time. For example, assume the vehicle 102 is located in Torrance, Calif. and the predicted start time of the next trip is 8:15 AM. The preconditioning unit 104 may receive forecast weather information from the weather server 108 for Torrance, Calif. from 8-9 AM.

The preconditioning unit 104 determines a time to initiate the preconditioning of the vehicle 102 (i.e., a preconditioning time). In one embodiment, to determine the preconditioning time, the preconditioning unit 104 uses the forecast weather information to predict conditions in the cabin at the start time of the next trip. The preconditioning unit 104 determines how much time is required to precondition the cabin from the predicted conditions to the conditions desired by a user at the start of the next trip. Based on the predicted start time and the time required to precondition the cabin under the predicted conditions, the preconditioning unit 104 determines the preconditioning time.

The preconditioning unit 104 waits for the preconditioning time. At the preconditioning time, the preconditioning unit 104 determines whether it is appropriate to begin preconditioning the vehicle 102. The preconditioning unit 104 may determine, for example, that it is not appropriate to begin preconditioning the cabin because due to the current conditions, the preconditioning can be delayed. As another example, the preconditioning unit 104 may determine it is not appropriate to begin because the vehicle 102 is no longer connected to a charging station. If the unit 104 determines that it is appropriate to begin, the unit 104 instructs the climate control system 105 to precondition the cabin according to a user's settings.

The tracking server 106 represents an entity that maintains information regarding trips by the electric vehicle 102. A trip is a route taken by a driver of the vehicle 102 from a starting location to an ending location. In one embodiment, after the end of a trip by the vehicle 102, the tracking server 106 receives from the vehicle 102 information regarding the trip and stores it. In one embodiment, for each trip, the information maintained by the tracking server 106 includes information on the start of the trip, end of the trip, and the trip that followed (i.e., the next trip).

When the tracking server 106 receives a request from the vehicle 102 for a start time of a next trip, the request includes information about the most recent trip by the vehicle 102 (i.e., the trip that just ended). The tracking server 106 searches for information on previous trips that are similar to the most recent trip. The tracking server 106 predicts the start time of the next trip based on the similar trips identified via the search.

The weather server 108 represents an entity that maintains weather information and transmits weather information to the electric vehicle 102. The weather server 108 stores weather information for different geographic locations. In one embodiment, the weather server 108 stores information on predicted weather conditions for various geographic locations at different times and dates in the future (i.e., forecast weather information). The forecast weather information maintained by the weather server 108 for a location at a time and date in the future may include one or more of the following: outdoor temperature, humidity, wind speed, wind direction, condition summary (e.g., cloudy, partly cloudy, sunny, showers, snowing, etc), and the rate of rain or snow fall. In one embodiment, the weather server 108 additionally stores weather information on past weather conditions. When the weather server 108 receives a request from the vehicle 102 for forecast weather information for a location at a time and date in the future, the weather server 108 searches for the requested information and provides it to the vehicle 102.

The wireless communication network 110 represents a communication pathway between the electric vehicle 102, the tracking server 106, and the weather server 108. In one embodiment, the wireless communication network 110 is a cellular network comprised of multiple base stations, controllers, and a core network that typically includes multiple switching entities and gateways. In one embodiment, the wireless communication network 110 is a wireless local area network (WLAN) that provides wireless communication over a limited area. In one embodiment, the WLAN includes an access point that connects the WLAN to the Internet. In one embodiment, the wireless communication network 110 is a combination of these.

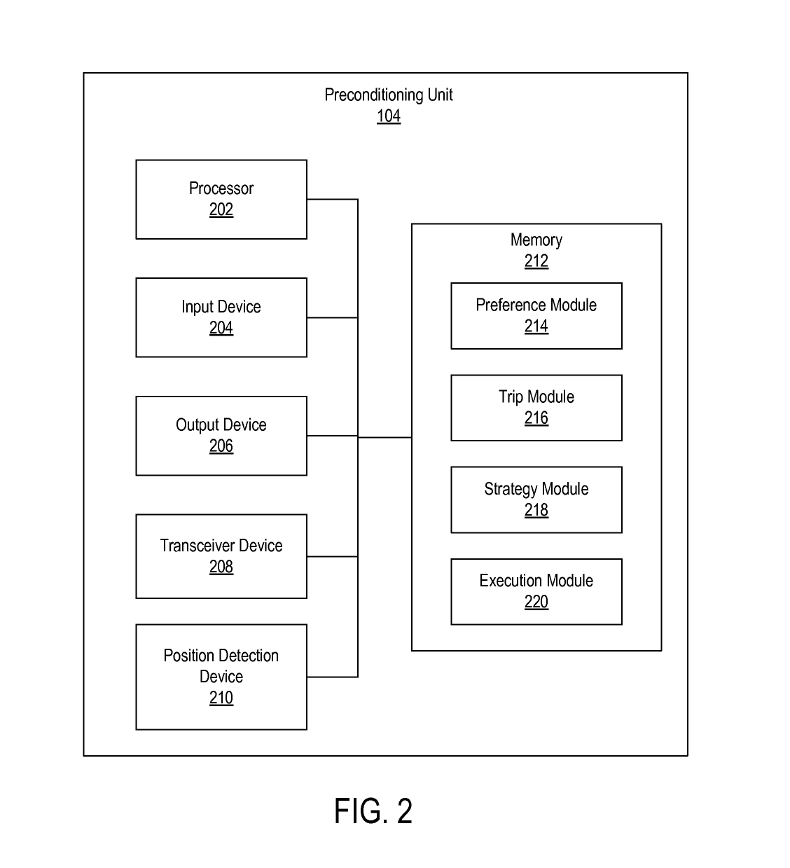

FIG. 2 is a high-level block diagram illustrating a detailed view of the preconditioning unit 104 according to one embodiment. The preconditioning unit 104 includes a processor 202, an input device 204, an output device 206, a transceiver device 208, a position detection device 210, and a memory 212.

The processor 202 processes data signals and may comprise various computing architectures including a complex instruction set computer (CISC) architecture, a reduced instruction set computer (RISC) architecture, or an architecture implementing a combination of instruction sets. Although only a single processor is shown in FIG. 2, multiple processors may be included. The processor 202 comprises an arithmetic logic unit, a microprocessor, a general purpose computer, or some other information appliance equipped to transmit, receive and process electronic data signals from the memory 212, the input device 204, the output device 206, the transceiver device 208, or the position detection device 210.

The input device 204 is any device configured to provide user input to the preconditioning unit 104 such as, a cursor controller or a keyboard. In one embodiment, the input device 204 can include an alphanumeric input device, such as a QWERTY keyboard, a key pad or representations of such created on a touch screen, adapted to communicate information and/or command selections to processor 202 or memory 212. In another embodiment, the input device 204 is a user input device equipped to communicate positional data as well as command selections to processor 202 such as a joystick, a mouse, a trackball, a stylus, a pen, a touch screen, cursor direction keys or other mechanisms to cause movement adjustment of an image.

The output device 206 represents any device equipped to display electronic images and data as described herein. Output device 206 may be, for example, an organic light emitting diode display (OLED), liquid crystal display (LCD), cathode ray tube (CRT) display, or any other similarly equipped display device, screen or monitor. In one embodiment, output device 206 is equipped with a touch screen in which a touch-sensitive, transparent panel covers the screen of output device 206. In one embodiment, the output device 206 is equipped with a speaker that outputs audio as described herein.

The transceiver device 208 represents a device that allows the preconditioning unit 104 to communicate with entities via the wireless communication network 110. The transceiver device 208 is used by the preconditioning unit 104 to communicate with the tracking server 106 and the weather server 108.

The position detection device 210 represents a device that communicates with a plurality of positioning satellites (e.g., GPS satellites) to determine the geographic location of the electric vehicle 102. In one embodiment, to determine the location of the vehicle 102, the position detection device 210 searches for and collects GPS information or signals from four or more GPS satellites that are in view of the position detection device 210. Using the time interval between the broadcast time and reception time of each signal, the position detection device 210 calculates the distance between the vehicle 102 and each of the four or more GPS satellites. These distance measurements, along with the position and time information received in the signals, allow the position detection device 210 to calculate the geographic location of the vehicle 102.

The memory 212 stores instructions and/or data that may be executed by processor 202. The instructions and/or data may comprise code for performing any and/or all of the techniques described herein. Memory 212 may be a dynamic random access memory (DRAM) device, a static random access memory (SRAM) device, Flash RAM (non-volatile storage), combinations of the above, or some other memory device known in the art. The memory 212 includes a plurality of modules adapted to communicate with the processor 202, the input device 204, the output device 206, the transceiver device 208, and/or the position detection device 210. In one embodiment, the modules included in the memory 212 are a preference module 214, a trip module 216, a strategy module 218, and an execution module 220.

The preference module 214 communicates with a user via the input device 204 and output device 206 to obtain settings for preconditioning the cabin of the electric vehicle 102. The preference module 214 stores settings provided by a user for preconditioning. In one embodiment, a setting provided by a user is whether or not to defrost the windows of the vehicle 102 prior to the start of a trip.

In one embodiment, a setting provided by a user to the preference module 214 is a temperature to which the user desires the cabin to be preconditioned to prior to the start of a trip. In one embodiment, the user may indicate to the preference module 214 that the temperate to which the cabin of the vehicle 102 is preconditioned should vary based on the conditions at the time of the preconditioning, such as the weather conditions outside/inside the vehicle 102 or the calendar season. For example, the user may indicate that if the temperature outside the vehicle 102 at the time of preconditioning is below 60° F., to precondition the cabin to 75° F. and if the outside temperature is greater than 60° F. to precondition to 70° F. As another example, the user may indicate to precondition the vehicle 102 to 75° F. during fall and winter months and 70° F. during the spring and summer months.

The trip module 216 provides information to the tracking server 106 regarding trips by the electric vehicle 102. For each trip by the vehicle 102, the trip module 216 transmits trip information to the tracking server 106. In one embodiment, the trip information includes start of the trip information and end of the trip information. The start of the trip information may include one or more of the following: starting geographic location, start date, and start time of the trip. The end of the trip information may include one or more of the following: ending geographic location, end date, and end time of the trip.

In one embodiment, the trip module 216 waits until the end of a trip to transmit information regarding the trip to the tracking server 106. In another embodiment, the trip module 216 transmits trip information in intervals. For example, the trip module 216 may transit start of trip information at the start of trip and end of the trip information at the end of the trip.

The strategy module 218 determines strategies for preconditioning the electric vehicle 102. The strategy module 218 detects the end of a trip. In one embodiment, the strategy module 218 determines that a trip has ended when the vehicle 102 is turned off after it has been traveling. In one embodiment, after the end of a trip by the vehicle 102, if the vehicle 102 is connected to a charging station for charging, the strategy module 218 determines a strategy for preconditioning the cabin of the vehicle 102 for the next trip. In one embodiment, the strategy determined by the strategy module 218 for preconditioning the vehicle 102 includes a time for initiating the preconditioning of the vehicle 102 (i.e., a preconditioning time), a temperature to which cabin will be preconditioned, and a predicted temperature in the cabin of the vehicle 102 at the predicted start time of the next trip.

In one embodiment, as part of determining a preconditioning strategy for a next trip, the strategy module 218 identifies a predicted start time for the next trip. In one embodiment, the strategy module 218 requests a start time for the next trip from the tracking server 106. In one embodiment, the request includes information of the trip that just ended. In another embodiment, a user (e.g., the driver) provides the start time of the next trip.

The strategy module 218 requests and receives forecast weather information from the weather server 108 for a time range that includes or is proximate to the start time. The strategy module 218 uses the forecast weather information to predict conditions in the cabin at the start time of the next trip. In one embodiment, a condition predicted by the strategy module 218 is the temperature in the cabin at the start time. In one embodiment, the predicted temperature in the cabin is determined based on a predicted temperature outside the vehicle 102 at the start time. The predicted temperature outside the vehicle 102 is included in the forecast weather information received from the weather server 108.

In one embodiment, the strategy module 218 predicts the temperature in the cabin by adding a certain amount of degrees to the predicted outdoor temperature. In one embodiment, the amount of degrees added by the strategy module 218 to the outdoor temperature varies based on the predicted outdoor temperature. In one embodiment, the strategy module 218 determines the amount of degrees to add using a stored degrees table. In one embodiment, the degrees table indicates the amount of degrees to add based on the outdoor temperature. For example, the table may indicate that if the predicted outdoor temperature is below 60° F., the predicted cabin temperature is the predicted outdoor temperature plus 10° F. Additionally, the table may indicate that if the outdoor temperature is between 61° F.-80° F., to add 15° F. and if the outdoor temperature is greater than 81° F., to add 20° F.

The strategy module 218 obtains from the preference module 214 the temperature set by a user for preconditioning the cabin and determines the amount of time needed by the climate control system to precondition the cabin from the predicted cabin temperature to the set temperature. In one embodiment, the strategy module 218 uses a time table to determine the amount of time needed to precondition the cabin. In one embodiment, the time table indicates for different temperature differences between the predicted cabin temperature and the set temperature, the amount of time needed by the climate control system 105 to precondition the cabin at a normal rate. In one embodiment, the degrees table and the time table are set by a system administrator.

To determine the time to initiate the preconditioning, the strategy module 218 subtracts the time need to precondition from the start time of the next trip. In one embodiment, the strategy module 218 includes in the strategy for preconditioning the vehicle 102, the preconditioning time along with the set temperature and the predicted cabin temperature.

The execution module 220 executes preconditioning strategies determined by the strategy module 218. When the strategy module 218 determines a strategy for preconditioning the vehicle 102 for a next trip, as part of executing the strategy, the execution module 220 identifies the preconditioning time determined by the strategy module 218 for the strategy. The execution module 220 waits for the preconditioning time.

At the preconditioning time, the execution module 220 determines whether it is appropriate to begin preconditioning the vehicle 102. In one embodiment, the execution module 220 determines not to precondition the vehicle 102 if the vehicle 102 is not connected to a charging station. Additionally, as part of determining whether it appropriate to begin the preconditioning, the execution module 220 determines the current temperature in the vehicle cabin. In one embodiment, the temperature is provided to the execution module 220 by a sensor in the cabin. If the current temperature of the cabin is within a set range of the cabin temperature predicted by the strategy module 218 (e.g., within ±4° F. of the predicted temperature), the execution module 220 instructs the climate control system 105 to precondition the cabin to the set temperature.

If the current cabin temperature is not within range and the difference between the current cabin temperature and set temperature is more than expected, the execution module 220 instructs the climate control system 105 to precondition the cabin to the set temperature but to precondition the cabin at a faster rate than planned. In one embodiment, the climate control system 105 determines the exact rate at which it needs to precondition the cabin 102 in order to reach the set temperature by the start time of the next trip.

On the other hand, if the current cabin temperature is not within range and the difference between the current cabin temperature and set temperature is less than expected, the execution module 220 has the strategy module 218 determine a new preconditioning time. At the new preconditioning time, the execution module 220 again goes through the process of determining whether it is appropriate to begin the preconditioning. Therefore, if the temperature difference is less than expected, the execution module 220 delays the preconditioning.

As an example of the above, assume that the set temperature is 70° F., that the predicted cabin temperature at the preconditioning time was 80° F., and that actual cabin temperature is 90° F. which is outside of a ±4° F. range of the predicted temperature. Under these conditions, at the preconditioning time the execution module 220 would instruct climate control system 105 to immediately begin cooling the cabin at a faster rate than normal so that the set temperature can be reached by the start time. On the other hand, if instead of the actual cabin temperature being 90° F. the cabin temperature is 75° F., the execution module 220 instructs the strategy module 218 to determine a new preconditioning time.

In one embodiment, when the execution module 220 instructs the execution module 220 to precondition the cabin to the set temperature, the execution module 220 determines whether to also instruct the climate control system 105 to turn on the defroster as part of the preconditioning. In one embodiment, the execution module 220 determines whether to instruct the climate control system 105 to turn on the defroster based on the average temperature outside of the vehicle 102 in a prior time period (e.g., the average temperature in the last 4 hours). In one embodiment, if average temperature is less than a frost temperature, the execution module 220 instructs the climate control system 105 to turn on the defroster because it can be assumed that the vehicle's windows have frost or condensation. On the other hand, if the average temperature is above the frost temperature, the execution module 220 does not instruct the climate control system 105 to turn on the defroster. In one embodiment, the execution module 220 obtains the average temperature from the weather server 108.

Some of the functionality described herein with regards to the preconditioning unit 104 may be performed by a remote server coupled to the wireless communication network 110. For example, a remote server such as the tracking server 106 may determine the strategy for preconditioning the vehicle 102 and the preconditioning unit 104 may execute the strategy. Additionally, some of the functionality described herein as being performed by a remote server (e.g., the tracking server 106 or the weather server 108 may be performed by the preconditioning unit 104.

It should be apparent to one skilled in the art that the preconditioning unit 104 may include more or less components than those shown in FIG. 2 without departing from the spirit and scope of the embodiments. For example, the preconditioning unit 104 may include additional memory, such as, for example, a first or second level cache, or one or more application specific integrated circuits (ASICs). Similarly, the preconditioning unit 104 may include additional input or output devices. In some embodiments one or more of the components can be positioned in close proximity to each other while in other embodiments these components can be positioned in different locations. For example the modules in memory 212 of the preconditioning unit 104 can be programs capable of being executed by one or more processors located in other devices in the electric vehicle 102.

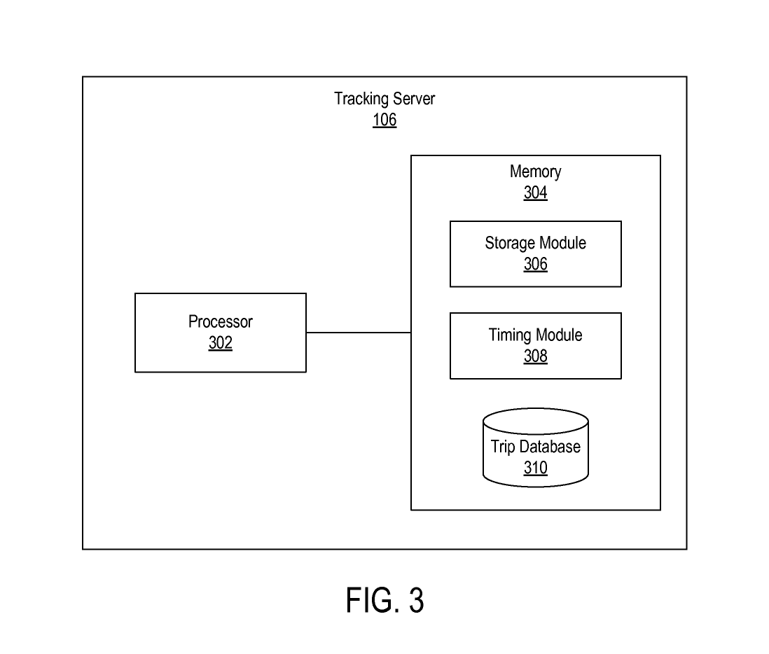

FIG. 3 is a high-level block diagram illustrating a detailed view of the tracking server 106 according to one embodiment. The tracking server 106 includes a processor 302 and a memory 304. In one embodiment, the processor 302 and memory 304 are functionally equivalent to the processor 202 and memory 212 of the tracking server 106. The memory 304 includes a storage module 306, a timing module 308, and a trip database 310.

The trip database 310 stores information regarding trips by the electric vehicle 102. In one embodiment, for each trip, the trip database 310 includes information on the start of the trip, end of the trip, the trip that followed (i.e., the next trip), and an identification number of the vehicle 102. The start of the trip and end of the trip information is described above. In one embodiment, the next trip information includes the start time and date of the next trip.

The storage module 306 updates the trip database 310. In one embodiment, when the storage module 306 initially receives information for a trip by the vehicle 102 (e.g., start of the trip and end of the trip information), the storage module 306 creates a new entry in the trip database 310 for the trip and stores the information received. At a later time, when the storage module 306 receives information for the next trip, the storage module 306 updates the entry in the trip database 310 to include the next trip information.

The timing module 308 predicts the start times of trips. When the timing module 308 receives from the vehicle 102 a request for a start time of a next trip, the timing module 308 uses information on the most recent trip by vehicle 102 to search the trip database 310 for previous trips. The timing module 308 searches for trips that are similar to the most recent trip. For example, the timing module 308 may search for previous trips that occurred on the same day of the week as the most recent trip, started at a similar time, started at the same location, ended at a similar time, and ended at the same location.

For the similar trips found by the search, the timing module 308 identifies the start times of the trips that followed the similar trips. The timing module 308 calculates the average of the identified start times. In one embodiment, the calculated average is a weighted average, such as where the most recent trips are given more weight. In embodiment, the timing module 308 additionally calculates the standard deviation of the start times. In one embodiment, the timing module 308 determines that the start time of the next trip by the vehicle 102 is the calculated average time. In one embodiment, the timing module 308 determines that the start time is the calculated average plus or minus the standard deviation. Thus, in this embodiment the start time is a time range (e.g., 5 PM±5 minutes).

It should be apparent to one skilled in the art that the tracking server 106 may include more or less components than those shown in FIG. 3 without departing from the spirit and scope of the embodiments.

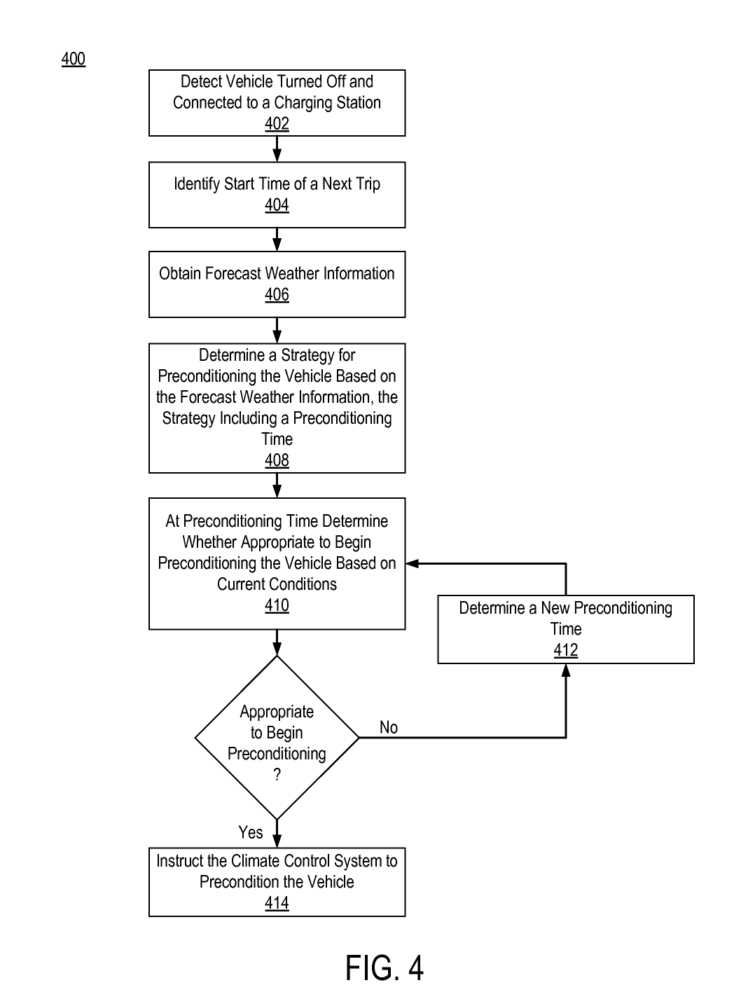

FIG. 4 is a flow chart of a method 400 for preconditioning the cabin of the electric vehicle 102 according to one embodiment. In one embodiment, the steps of the method 400 are implemented by the processor 202 of the preconditioning unit 104 executing instructions that cause the desired actions. Those of skill in the art will recognize that one or more of the method steps may be implemented in embodiments of hardware and/or software or combinations thereof. For example, instructions for performing the described actions are embodied or stored within a computer readable medium. Furthermore, those of skill in the art will recognize that other embodiments can perform the steps of FIG. 4 in different orders. Moreover, other embodiments can include different and/or additional steps than the ones described here.

Assume for purposes of this example, that the electric vehicle 102 has been turned off after the end of a trip and that the driver connected the vehicle 102 to a charging station for charging. The preconditioning unit 104 detects 402 that the vehicle 102 has been turned off and is connected to a charging station. The preconditioning unit 104 identifies 404 a start time of a next trip by the vehicle 102. In one embodiment, the preconditioning unit 104 receives the start time from the tracking server 106.

The preconditioning unit 104 obtains 406 forecast weather information from the weather server 108 for a time period that includes or is proximate to the start time of the next trip. Based on the forecast weather information, the preconditioning unit 104 determines 408 a strategy for preconditioning the vehicle 102, where the strategy includes a time for initiating the preconditioning.

At the preconditioning time, the preconditioning unit 104 determines 410 whether it is appropriate to begin the preconditioning of the vehicle 102. If it is not appropriate to begin, the preconditioning unit 104 determines 412 a new preconditioning time. On the other hand, if it is appropriate to begin the preconditioning, the preconditioning unit 104 instructs 414 the climate control system 105 to precondition the cabin according to a user's settings.

In other embodiments, a set amount time prior to the preconditioning time, the preconditioning unit 104 determines whether it will be appropriate to precondition at the preconditioning time. For example, the preconditioning unit 104 may make the determination 10 minutes prior to the preconditioning time.

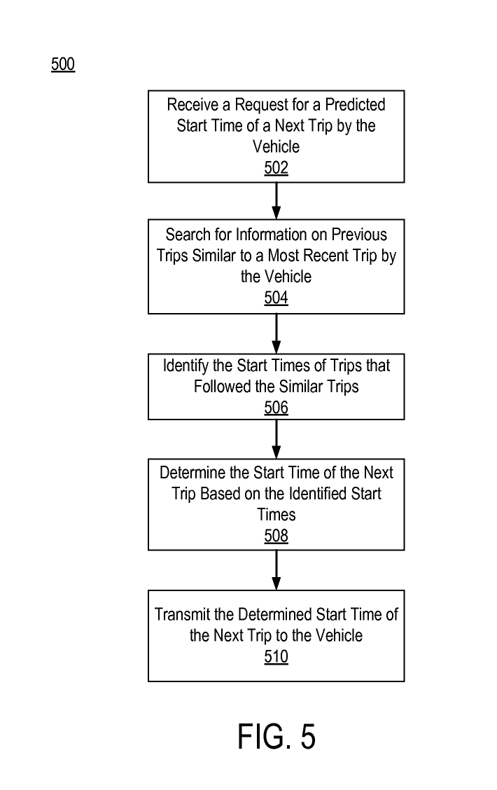

FIG. 5 is a flow chart of a method 500 for predicting a start time of a next trip by the electric vehicle 102 according to one embodiment. In one embodiment, the steps of the method 500 are implemented by the processor 302 of the tracking server 106 executing instructions that cause the desired actions. Those of skill in the art will recognize that one or more of the method steps may be implemented in embodiments of hardware and/or software or combinations thereof. Furthermore, those of skill in the art will recognize that other embodiments can perform the steps of FIG. 4 in different orders. Moreover, other embodiments can include different and/or additional steps than the ones described here.

The tracking server 106 receives 502 a request for a predicted start time of a next trip by the vehicle 102. In one embodiment, the request includes information on the most recent trip by the vehicle 102. The tracking server 106 searches 504 for stored information on previous trips by the vehicle 102 that are similar to the most recent trip.

For the similar trips found by the search, the tracking server 106 identifies 506 the start times of the trips that followed the similar trips. Based on the start times of the trips that followed, the tracking server 106 determines 508 the start time of the next trip by the vehicle 102. The tracking server 106 transmits 510 the determined start time of the next trip to the vehicle 102.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments present disclosure without departing from the spirit and scope of the disclosure.

1. A computer-implemented method for preconditioning a cabin environment of a vehicle, the method comprising:
identifying a predicted start time of a next trip by a vehicle, the predicted start time determined based on a plurality of previous trips by the vehicle;
obtaining forecast weather information that describes predicted weather conditions at or approximate to the predicted start time of the next trip;
determining a preconditioning strategy for preconditioning a cabin of the vehicle, the preconditioning strategy including a preconditioning time for initiating preconditioning of the cabin, the preconditioning time prior to the predicted start time of the next trip and determined based on the forecast weather information; and
executing the preconditioning strategy.

2. The method of claim 1, wherein identifying the predicted start time of the next trip comprises:
searching for previous trips similar to the current trip;
identifying start times of trips that followed the similar trips; and
determining the predicted start time of the next trip based on the identified start times.

3. The method of claim 2, wherein the predicted start time of the next trip is the average of the identified start times.

4. The method of claim 2, wherein the predicted start time of the next trip is the average of the identified start times plus or minus the standard deviation of the identified start times.

5. The method of claim 1, further comprising:
predicting conditions in the cabin at the predicted start time of the next trip based on the forecast weather information;
determining an amount of time needed to precondition the cabin from the predicted conditions to set conditions; and
determining the preconditioning time based on the predicted start time and the amount of time needed to precondition the cabin.

6. The method of claim 1, further comprising:
predicting a temperature in the cabin at the predicted start time of the next trip based on the forecast weather information;
determining an amount of time needed to precondition the cabin from the predicted temperature to a set temperature; and
determining the preconditioning time based on the predicted start time and the amount of time needed to precondition the cabin.

7. The method of claim 1, wherein executing the strategy comprises:
responsive to a temperature of the cabin at the preconditioning time being within a set range of a predicted cabin temperature, preconditioning the cabin.

8. The method of claim 1, wherein executing the strategy comprises:
responsive to a temperature of the cabin at the preconditioning time not being within a set range of a predicted cabin temperature and a difference between the temperature at the preconditioning time and a set temperature being more than expected, preconditioning the cabin at a rate faster than planned.

9. The method of claim 1, wherein executing the strategy comprises:
responsive to a temperature of the cabin at the preconditioning time not being within a set range of a predicted cabin temperature and a difference between the temperature at the preconditioning time and a set temperature being less than expected, determining a new preconditioning time.

10. A computer-implemented method for preconditioning a cabin environment of a vehicle, the method comprising:
identifying a predicted start time of a next trip by a vehicle, the predicted start time determined based on a plurality of previous trips by the vehicle;
determining a preconditioning strategy for preconditioning a cabin environment of the vehicle, the preconditioning strategy including a preconditioning time for initiating preconditioning of the cabin, the preconditioning time prior to the predicted start time of the next trip; and
executing the preconditioning strategy.

11. The method of claim 10, wherein identifying the predicted start time of the next trip comprises:
searching for previous trips similar to the current trip;
identifying start times of trips that followed the similar trips; and
determining the predicted start time of the next trip based on the identified start times.

12. The method of claim 11, wherein the predicted start time of the next trip is the average of the identified start times.

13. The method of claim 11, wherein the predicted start time of the next trip is the average of the identified start times plus or minus the standard deviation of the identified start times.

14. The method of claim 10, wherein executing the strategy comprises:
responsive to a temperature of the cabin at the preconditioning time being within a set range of a predicted cabin temperature, preconditioning the cabin.

15. The method of claim 10, wherein executing the strategy comprises:
responsive to a temperature of the cabin at the preconditioning time not being within a set range of a predicted cabin temperature and a difference between the temperature at the preconditioning time and a set temperature being more than expected, preconditioning the cabin at a rate faster than planned.

16. The method of claim 10, wherein executing the strategy comprises:
responsive to a temperature of the cabin at the preconditioning time not being within a set range of a predicted cabin temperature and a difference between the temperature at the preconditioning time and a set temperature being less than expected, determining a new preconditioning time.

17. A computer-implemented method for preconditioning a cabin environment of a vehicle, the method comprising:
identifying a start time of a next trip by a vehicle;
retrieving forecast weather information that describes predicted weather conditions at or approximate to the start time of the next trip;
determining a preconditioning strategy for preconditioning a cabin environment of the vehicle, the preconditioning strategy including a preconditioning time for initiating preconditioning of the cabin, the preconditioning time prior to the start time of the next trip and determined based on the retrieved forecast weather information; and
executing the preconditioning strategy.

18. The method of claim 17, further comprising:
predicting conditions in the cabin at the predicted start time of the next trip based on the forecast weather information;
determining an amount of time needed to precondition the cabin from the predicted conditions to set conditions; and
determining the preconditioning time based on the predicted start time and the amount of time needed to precondition the cabin.

19. The method of claim 17, further comprising:
predicting a temperature in the cabin at the predicted start time of the next trip based on the forecast weather information;
determining an amount of time needed to precondition the cabin from the predicted temperature to a set temperature; and
determining the preconditioning time based on the predicted start time and the amount of time needed to precondition the cabin.

20. The method of claim 17, wherein executing the strategy comprises:
responsive to a temperature of the cabin at the preconditioning time being within a set range of a predicted cabin temperature, preconditioning the cabin.
